(19) United States
(12) Patent Application Publication
(10) Pub. No.: US 2015/0142480 A1
(43) Pub. Date: May 21, 2015

(54) SYSTEM AND METHOD FOR PRESCRIPTION MANAGEMENT

(71) Applicant: Steven M. Hayden, Wetumpka, AL (US)

(72) Inventor: Steven M. Hayden, Wetumpka, AL (US)

(21) Appl. No.: 14/548,257

(22) Filed: Nov. 19, 2014

Related U.S. Application Data
(60) Provisional application No. 61/906,191, filed on Nov. 19, 2013.

(51) Int. Cl. G06Q 40/08; G06F 19/00

(52) U.S. Cl. CPC G06Q 40/08; G06F 19/3456; G06F 19/322
USPC 705/4

(57) ABSTRACT

A system and method for prescription management is disclosed. The system includes a prescription management non-transitory storage medium that guides a healthcare provider licensed to write one or more prescriptions, the healthcare provider licensed to write the one or more prescriptions chooses from one or more prescriptions offered by an insurance carrier. The method includes a patient user enrolling in a Medicaid or a health insurance plan on a website, controlling the web database system by a Medicaid provider or a health insurance carrier and the Medicaid provider or the health insurance carrier selecting one or more economical prescriptions from the web database system to treat the patient user.

This application claims priority to U.S. Provisional Application No. 61/906,191 filed on Nov. 19, 2013, the entire disclosure of which is incorporated by reference.

### BACKGROUND OF THE INVENTION

The present invention generally relates to a system and method for prescription management. More specifically, the present invention is a system and method for prescription management.

A comprehensive web based solution has never been available on the Internet for Medicaid or insurance companies. Insurance companies want control over the prescribing process to influence prescribing patterns. Insurance companies and Medicaid are not licensed by themselves to dispense medicines without using licensed physicians and nurses that have drug enforcement agency or DEA licenses. The constantly changing control is not possible by retraining practitioners. It is only possible when a program controlled by a carrier such as Medicaid involving the physician creates prompts to control choices offered to prescriber.

### SUMMARY OF THE INVENTION

The present invention generally relates to a system and method for prescription management. More specifically, the present invention is a system and method for prescription management.

A system for prescription management may include a server system with a processor system, a communications interface, a communications system, an input system and an output system, the server system having access to a communications network, a memory system with an operating system, a communications module, a web browser module and a prescription management non-transitory storage medium, the prescription management non-transitory storage medium includes a plurality of prescription management information that controls and records dispensing one or more medications to a patient user, the prescription management information guides a healthcare provider licensed to write one or more prescriptions, the healthcare provider licensed to write the one or more prescriptions chooses from one or more programs offered by an insurance carrier, the healthcare provider licensed to write the one or more prescriptions changes the one or more programs and generates the one or more changed prescriptions, the healthcare provider licensed to write the one or more prescriptions overrides the prescription management information and a website displaying the prescription management information that resides on the prescription management non-transitory storage medium allowing the patient user to enroll in Medicaid or health insurance on the website.

The method for prescription management may include the steps of a patient user enrolling in a Medicaid or health insurance plan on a website, assigning or having the patient user select a provider who authorizes one or more prescriptions, recording the patent user's medical history and symptoms in a web database system residing on the website, controlling the web database system by a Medicaid provider or a health insurance carrier, the Medicaid provider or the health insurance carrier selecting one or more economical prescription from the web database system to treat the patient user and giving the Medicaid provider or the health insurance carrier a predetermined period of time for the prescription and one or more differing dosages.

It is an object of the present invention to provide a system and method for prescription management that is a comprehensive web based prescription management solution that has never been available on the Internet for Medicaid or insurance companies.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a system for prescription management, in accordance with one embodiment of the present invention.

FIG. 2A illustrates a block diagram of a client system, in accordance with one embodiment of the present invention.

FIG. 2B illustrates a block diagram of a server system, in accordance with one embodiment of the present invention.

FIG. 3 illustrates a flowchart of a method for prescription management, in accordance with one embodiment of the present invention.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

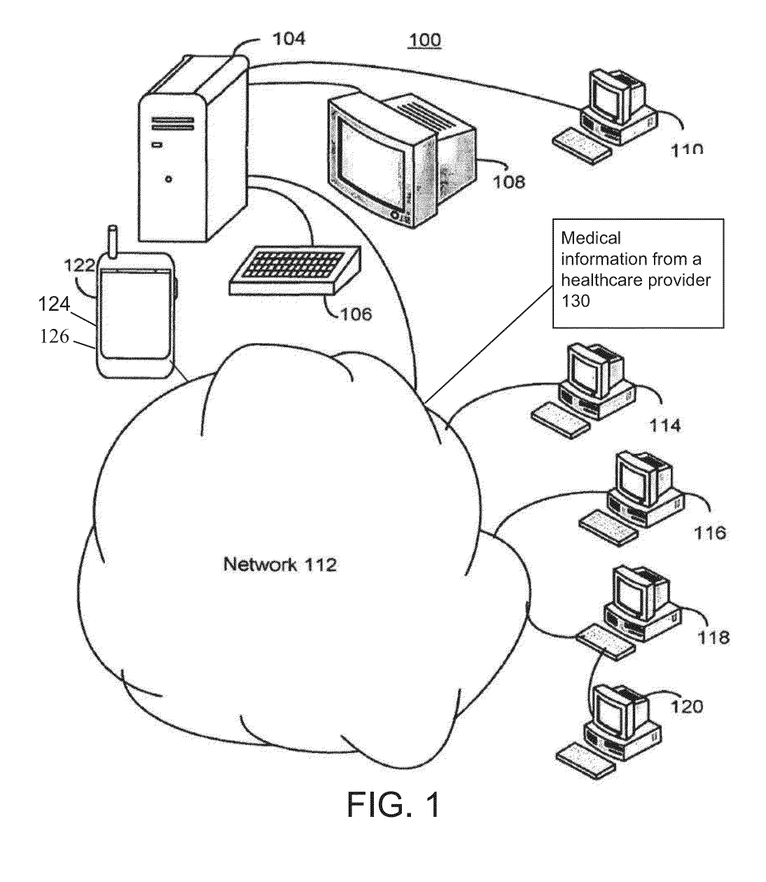

FIG. 1 illustrates a system overview of a system 100 for prescription management. The system 100 may include a server system 104, an input system 106, an output system 108, a plurality of client systems 110, 114, 116, 118 and 120, a communications network 112 and a handheld wireless device 122. In other embodiments, the system 100 may include additional components and/or may not include all of the components listed above.

The server system 104 may include one or more servers. One server system 104 may be the property of the distributor of any related software or non-transitory storage media. In other embodiments, the system 100 may include additional components and/or may not include all of the components listed above.

The input system 106 may be utilized for entering input into the server system 104, and may include any one of, some of, any combination of, or all of a keyboard system, a mouse system, a track ball system, a track pad system, a plurality of buttons on a handheld system, a mobile system, a scanner system, a wireless receiver, a microphone system, a connection to a sound system, and/or a connection and/or an interface system to a computer system, an intranet, and/or the Internet (i.e., Infrared data association or IrDA, universal serial bus or USB).

The output system 108 may be utilized for receiving output from the server system 104, and may include any one of, some of, any combination of or all of a monitor system, a wireless transmitter, a handheld display system, a mobile display system, a printer system, a speaker system, a connection or an interface system to a sound system, an interface system to one or more peripheral devices and/or a connection and/or an interface system to a computer system, an intranet, and/or the Internet.

The system 100 illustrates some of the variations of the manners of connecting to the server system 104, which may be an information providing website (not shown). The server system 104 may be directly connected and/or wirelessly connected to the plurality of client systems 110, 114, 116, 118 and 120 and may be connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals. The client systems 110, 114, 116, 118 and 120 may be any system that an end user may utilize to access the server system 104. For example, the client systems 110, 114, 116, 118 and 120 may be personal computers, workstations, laptop computers, game consoles, handheld network enabled audio/video players, mobile devices and/or any other network appliance.

The client system 120 may access the server system 104 via the combination of the communications network 112 and another system, which in this example may be the client system 118. The client system 120 may be a handheld wireless device 122, such as a mobile phone, tablet or a handheld network-enabled audio/music player, which may also be utilized for accessing network content. The client system 120 may be a cell phone with an operating system or SMARTPHONE® 124 or a tablet with an operating system or IPAD® 126.

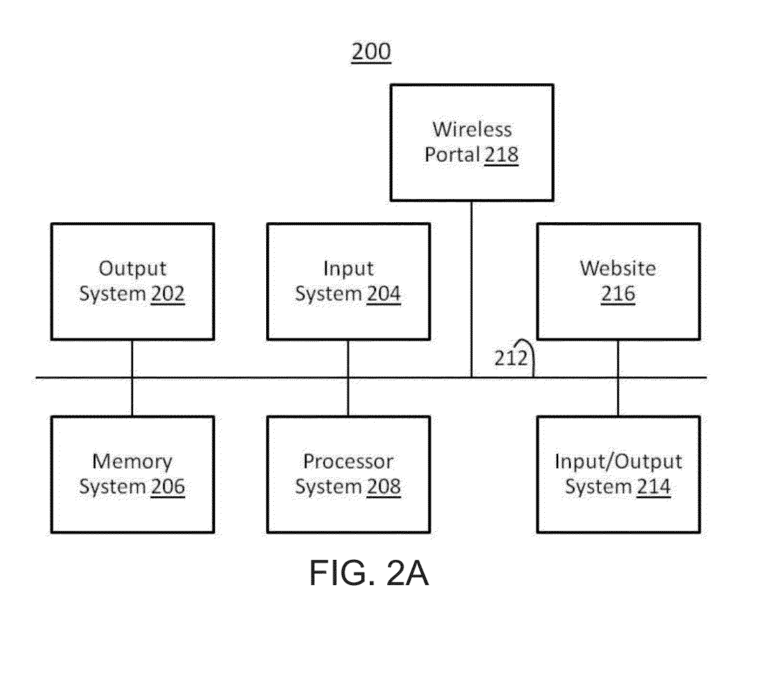

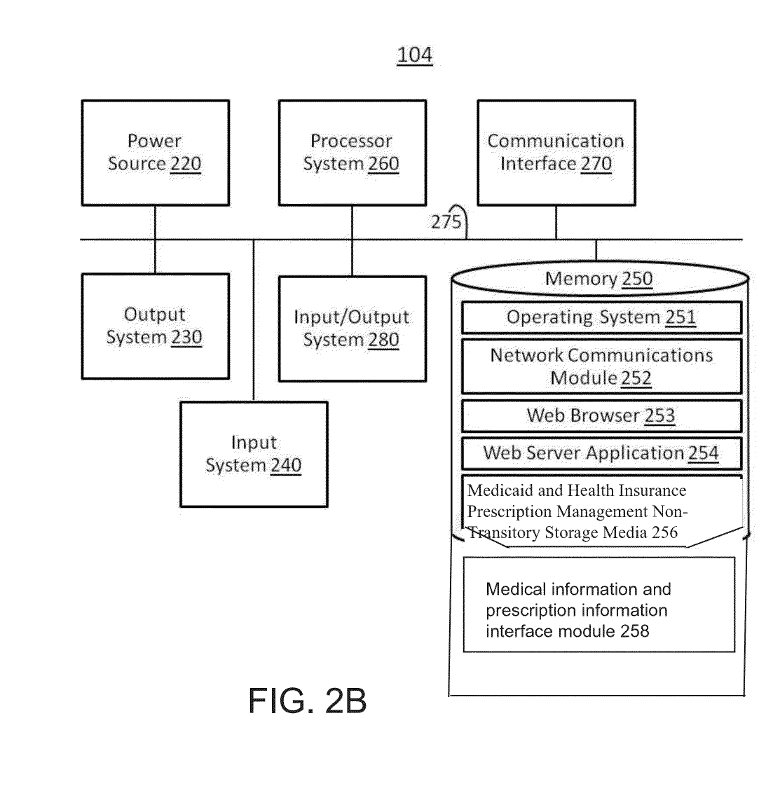

FIG. 2A illustrates a block diagram of a client system 200 that may be utilized as one of the system units for prescription management. The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122, SMARTPHONE® 124 or IPAD® 126 that may be utilized as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB). The memory system 206 may include, any one of, some of, any combination of or all of a long-term storage system, such as a hard drive, a short term storage system, such as a random access memory; a removable storage system, such as a floppy drive or a removable drive, and/or a flash memory. The memory system 206 may include one or more machine readable mediums that may store a variety of different types of information. The term machine readable medium may be utilized to refer to any medium that may be structurally configured for carrying information in a format that may be readable by a machine. One example of a machine-readable medium may be a computer-readable medium. The memory system 206 may store a non-transitory storage media for prescription management.

The processor system 208 may include any one of, some of, any combination of, or all of multiple parallel processors, a single processor, a system of processors having one or more central processors and/or one or more specialized processors dedicated to specific tasks. The processor system 208 may implement the programs stored in the memory system 206. The communications system 212 may communicatively link the output system 202, the input system 204, the memory system 206, the processor system 208, and/or the input/output system 214 to each other. The communications system 212 may include any one of, some of, any combination of, or all of one or more electrical cables, fiber optic cables, and/or means of sending signals through air or water (i.e., wireless communications), or the like. Some examples of means of sending signals through air and/or water may include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore may be an output device and accept input when the screens may be pressed by a finger or a stylus. The touch sensitive screens may be sensitive to heat, capacitance and/or pressure. One or more of the input/output devices may be sensitive to a voltage or a current produced by a stylus. The input/output system 214 is optional, and may be utilized in addition to or in place of the output system 202 and/or the input device 204.

The client systems 110, 114, 116, 118, 120 and the handheld wireless device 122 may also be tied into a website 216 or a wireless portal 218 which may also be tied directly into the communications system 212. Any website 216 or wireless portal 218 may also include a non-transitory storage media and a website module (not shown) to maintain, allow access to and run the website as well.

FIG. 2B illustrates a block diagram of a server system 104 that may be utilized for prescription management. The server system 104 may include a power source 220, an output system 230, an input system 240, a memory system 250, which may store an operating system 251, a communications module 252, a web browser module 253, a web server application 254, a prescription management non-transitory storage media 256 and a medical information and prescription information interface module 258. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB).

The memory system 250 may include any one of, some of, any combination of, or all of a long term storage system, such as a hard drive; a short term storage system, such as random access memory; or a removable storage system, such as a floppy drive or a removable drive and/or a flash memory. The memory system 250 may include one or more machine readable mediums that may store a variety of different types of information. The term machine readable medium may be utilized to refer to any medium capable of carrying information that may be readable by a machine. One example of a machine-readable medium may be a computer-readable medium such as a non-transitory storage media. The memory system 250 may store one or more machine instructions for prescription management. The operating system 251 may control all software and hardware of the system 100. The communications module 252 may enable the server system 104 to communicate on the communications network 112. The web browser module 253 may allow for browsing the Internet. The web server application 254 may serve a plurality of web pages to client systems that request the web pages, thereby facilitating browsing on the Internet. The prescription management non-transitory storage media 256 may reside on the memory system 250. The medical information and prescription information interface module 258 may receive medical information from the healthcare provider and integrates the medical information with the prescription management information selecting one or more economical prescriptions from the provided prescription list to treat the patient user. The one or more economical prescription includes one or more warnings for dangerous interactions. The healthcare provider licensed may write the one or more prescriptions select a diagnosis from a provided diagnosis list. The medical information may be selected from the group consisting of one or more laboratory results, information from one or more physical exams, information from one or more x-rays, information from one or more MRIs, one or more physical histories, one or more ICD codes and one or more diagnosis codes. The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 may allow the server system 104 to interface with the communications network 112. In this embodiment, the output system 230 may send communications to the communication interface 270. The communications system 275 communicatively links the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water may include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore may be an output device and accept input when the screens may be pressed by a finger or a stylus. The touch sensitive screens may be sensitive to heat and/or pressure. One or more of the input/output devices may be sensitive to a voltage or a current produced by a stylus. The input/output system 280 may be optional and may be utilized in addition to or in place of the output system 230 and/or the input system 240.

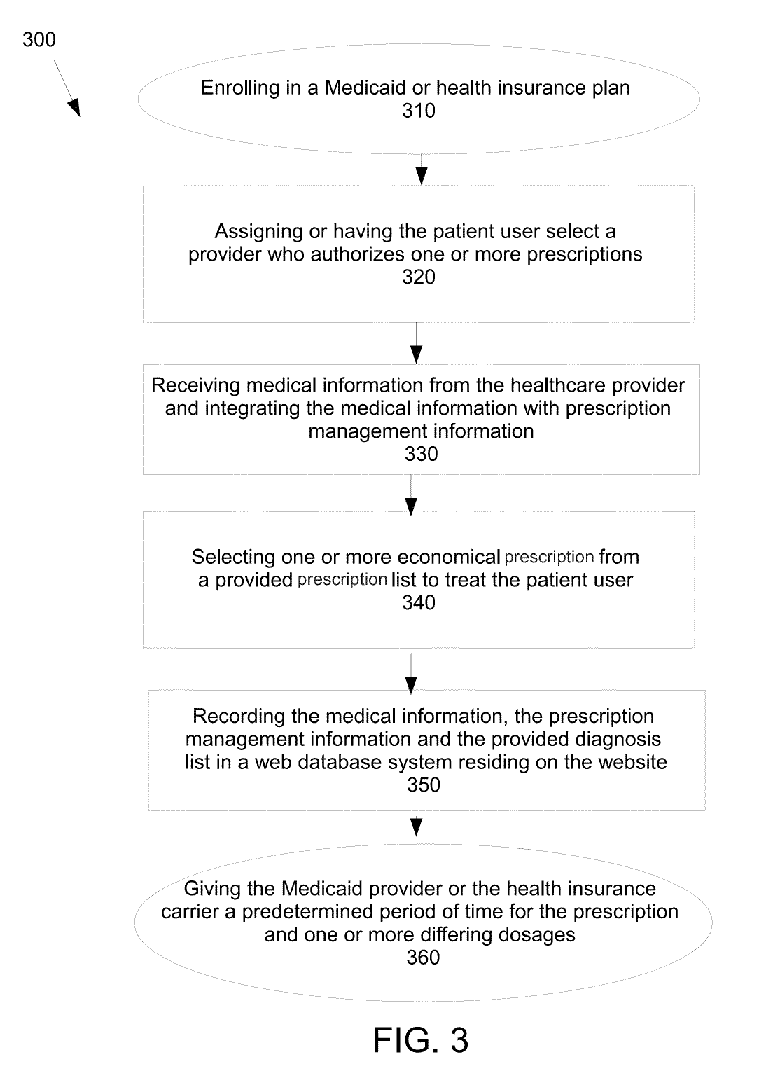

FIG. 3 illustrates a flowchart of a method 300 for prescription management. The method 300 may include the steps of a patient user enrolling in a Medicaid or health insurance plan 310, assigning or having the patient user select a provider who authorizes one or more prescriptions 320, receiving medical information from the healthcare provider 330, selecting one or more economical prescriptions to treat the patient user 340, recording the medical information 350 and giving the Medicaid provider or the health insurance carrier a predetermined period of time for the prescription and one or more differing dosages 360.

The enrolling step 310 may include enrolling in a Medicaid or health insurance plan on a website. The assigning or having step 320 may include the one or more prescriptions are regulated by state law as one or more controlled substances and are dispensed by a pharmacy. The receiving step 330 may include integrating the medical information with prescription management information. The selecting step 340 may include selecting one or more economical prescriptions from a provided prescription list. The recording step 350 may include recording the medical information, the prescription management information and the provided diagnosis list in a web database system may reside on the website. The giving step 360 may include notification of the patient's side effects of medication and record of transaction is sent to their email.

A non-transitory computer storage media having instructions stored thereon which, when executed, may execute the steps of the overall method.

The web based site may control and influence the decision pattern of prescribers and ultimately controls and records dispensing of medications to the beneficiaries under a program. The program guides providers who are licensed to write prescriptions into choosing from among the selected choices offered by the program from the insurance carrier. The carrier may change the program and the program generates the prescription. He may ordinarily only choose from among the options offered by the computer program which is controlled by the insurance programmer or Medicaid. Exceptions for emergencies or overrides or exceptional conditions may be made available but such exceptions will be recorded.

The patient is a beneficiary under a state Medicaid program or insurance plan. The patient goes to a website to enroll in a benefits plan. After enrolling in the benefits plan the patient is assigned to and/or selects a provider who is authorized to prescribe controlled prescriptions that are regulated by state law as controlled substances or require prescriptions to be dispensed at a pharmacy. When the patient sees the provider their history and symptoms are recorded in web database system. The web accessible data system is known as WADS and access to it is controlled by either Medicaid or insurance carrier using usernames and passwords. After history and symptoms are entered into the WADS a group of possible diagnosis is automatically computer generated. The provider physician or nurse practitioner may select a diagnosis from the list or create his own. After symptoms and diagnosis are selected the provider is prompted to select from a list of the most economical choices to treat the disease. Then he is given a predetermined amount of time such as a list of days, a week or time or parameters for the prescription. He is also offered differing dosages. The provider is given multiple choices by the WADS program based on the symptom and diagnosis. Ultimately the prescription choice is done by the provider who is a licensed nurse or physician who may prescribe medicines. This is a form of managed care where the computer is managing the multiple choices that are offered based on symptom and diagnosis. The computer program is controlling choices offered to prescribing physicians, nurses, dentist and other prescribing individuals. The prescription remains on the computer system until it is filled by an authorized pharmacy. The pharmacist may receive the prescription automatically if the patient selects the option. The prescription is received by an authorized representative of the patient. Notification of the patient of side effects of medication and record of transaction may be sent to their email.

The system acts as a copilot. It may use the input vital signs (blood pressure up or down) laboratory data, x-ray reports (i.e., pneumonia improving worsening) to propose diagnosis like hypertension pneumonia and acute Myocardial infarction. The system may also suggest tests vital signs more labs or more diagnostic tests. When diagnosis is certain and confirmed by a human and the human is ready to treat with medication. The system may propose a selection of medications appropriate for conditions.

Electronic Health records systems are widespread. None of the present systems offer a selection of economical choices for a physician when making health care decisions. The health insurer owns the system and physicians clinics hospitals participate. That's what is new about the system and method for prescription management. In the past old systems were bought by physicians clinics and hospitals but not health insurers or payers. The physicians or hospital wanted complete autonomy. However, insurers want to influence choices of physicians serving their patients but still allow the physician to make final decision. However the usual electronic health records systems were designed to sell to physicians, clinics and hospitals not insurers and serve the needs of physicians, hospitals, and clinics. The electronic health records that physicians use were not created to influence the decisions of physicians at time of making a decision about patient healthcare.

Medicaid, Medicare, Blue Cross, Health Partners, Viva (health insurer) and others are not able to influence decisions using the software physician's use when prescribing drugs ordering tests and making other patient related decisions that will cost the health care system. However it is possible to design a system that influences decision making of physicians at the time of ordering prescriptions lab tests and making decisions that will ultimately cost the insurer. The system and method for prescription management influences decisions that helps make diagnosis and then provides choices at time of making decision such as prescribing drugs or order tests. The system and method for prescription management may provide a series of choices with the first choice being the most economical. The physician is not forced into selecting the most economical option but the most economical choice is easiest to access and offered first. A physician may select more expensive choices but must make greater effort and be informed of potential of more economical choices. The goal is not to strip the physician of choice but rather to provide natural flow toward more economical practices. The same is true of diagnostic tests. Diagnostic tests are often needlessly repeated because past test results are not easily available. When a physician orders a test he should have information about when the last test of same or similar nature was ordered and what the results were. Unfortunately the test was done at other clinics or hospitals that did not share the information with physician at the time of requesting new test. By using the system and method for prescription management when ordering a test, it then would provide a compatible lab, a magnetic resonance imaging or MRI X-ray and computed tomography or CT results into a shared data site. This information should be available to the system and method for prescription management and a physician at the time of ordering a test or treatment to make best choice.

When a lab or x-ray department MRI reimbursed by the system and method for prescription management performs a test or procedure that information must be available to physicians when ordering new test at the time when the decision to do repeat testing is made. This prevents redundant useless testing and allows the physician and system to have more information. Information is necessary to make good decisions even for the system and method for prescription management that will provide options. All recently done lab x-ray and CT results as well as history should be available to the system and the physician. As computer systems improve artificial intelligence with allow the system itself to suggest better choices to physician to manage an individual patient's healthcare. When patients give a history medication or labs or x-ray results it is unreliable. The system should have all patients past history present complaints family history and other information useful to justify decisions. The system may present the information to a decision maker the physician at time of decision to make the most practical choices. In fact the computer may generate a list of choices regarding tests and clinical strategies for the physician and physician may choice among the choices or select own path. This system requires physician's clinics and hospitals to work with an insurer to collect data that may be useful for analysis by system and physician. The system uses the information to suggest choices while the physician makes final choice. For such a system to be developed requires collaborative effort between physician's clinics hospitals and software designer. The insurer needs clinic and hospital and physicians to work on small scale to develop system in hospital and clinics. Once all the bugs are worked out in a rural health care setting using rural hospital physician and clinics, the program may be expanded. Even a wealthy insurer may not work out the bugs from a system without collaboration of physicians and hospital and clinic. The system must consider the needs of all those who are required to participate. Eventually many outpatient visits will be done online and electronically. Making all available information from past available at decision time is essential for most efficient choices to be offered.

The insurer would likely have an interest since whoever controls such software has more efficient system for managing health care decisions. If an insurer controls the system and method for prescription management, the insurer has competitive advantage against other insurers. But for an insurer to take care of a patient they must know the needs of patients and give physicians ways of making best choices. The best information system may offer the best economical and effective treatment choices for physicians caring for patients.

Many isolated counties are isolated and have one hospital with five clinics and ten medical physicians. Only one hospital and ten physicians to train for an isolated community of ten thousand to twenty thousand or more but the impact of the system and method for prescription management on provider behavior may be accessed these isolated community. When the program efficiency of the system and method for prescription management is maximized in these isolated rural settings models consider transferring it to municipalities.

The system and method for prescription management was designed to offer physician best choices of medical care when giving orders to save society money while proving quality care. When the insurer controls the insurance market and would simply offer the system free to all their providers knowing that it saves them about 25% on prescription costs alone. Insurers have a contract that allows them to terminate without cause. Eventually insurers could terminate providers that do not use an electronic medical record or EMR that represent the need of insurer. The system has a bias that constantly suggests but does not order less expensive alternatives in end of live care where 25% of all health care costs occur. Patients should like it because a lot of health care suggestions are based on logic and customized health care suggestions which a computer based system may provide. Eventually the EMR is like artificial intelligence almost as smart as the physician as diagnosing disease. But it will just like an airplane, always need a physician or midlevel practitioner to approve the select the computers suggestion or deny all suggested choices.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention

1. A system for prescription management, comprising:
a server system with a processor system, a communications interface, a communications system, an input system and an output system, the server system having access to a communications network;
a memory system with an operating system, a communications module, a web browser module and a prescription management non-transitory storage medium, the prescription management non-transitory storage medium includes a plurality of prescription management information that controls and records dispensing one or more medications to a patient user, the prescription management information guides a healthcare provider licensed to write one or more prescriptions, the healthcare provider licensed to write the one or more prescriptions chooses from one or more prescriptions offered by an insurance carrier, the healthcare provider licensed to write the one or more prescriptions changes the one or more programs and generates the one or more changed prescriptions, the healthcare provider licensed to write the one or more prescriptions may override the prescription management information, the healthcare provider licensed to write the one or more prescriptions selects a diagnosis from a provided diagnosis list and a medical information and prescription information interface module that receives medical information from the healthcare provider and integrates the medical information with the prescription management information selecting one or more economical prescriptions from the provided prescription list to treat the patient user, the healthcare provider selects a most economical prescription; and a website displaying the prescription management information that resides on the prescription management non-transitory storage medium allowing the patient user to enroll in Medicaid or health insurance on the website.

2. The system according to claim 1, further comprising a client system.

3. The system according to claim 2, wherein the client system includes an output system, an input system, a memory system, a processor system and a communications system.

4. The system according to claim 3, wherein the client system is selected from the group consisting of a personal computer, a laptop computer, a tablet computer or a cell phone with an operating system.

5. The system according to claim 4, wherein the client system accesses the server system via the communications network.

6. The system according to claim 5, wherein the communications network is selected from the group consisting of the Internet, one or more local area networks or one or more wide area networks.

7. The system according to claim 1, wherein the prescription management information is overridden by the healthcare provider during an emergency.

8. The system according to claim 1, wherein the medical information is selected from the group consisting of one or more laboratory results, information from one or more physical exams, information from one or more x-rays, information from one or more MRIs, one or more physical histories, one or more ICD codes and one or more diagnosis codes.

9. The system according to claim 1, wherein a prescription choice includes one or more warnings for dangerous interactions.

10. The system according to claim 1, wherein a pharmacist receives notification of the patient user's medication side effects and a record of transaction by email.

11. A method for prescription management, comprising the steps of:
a patient user enrolling in a Medicaid or a health insurance plan on a website;
assigning or having the patient user selects a provider who authorizes one or more prescriptions;
receiving medical information from the healthcare provider and integrating the medical information with prescription management information;
selecting one or more economical prescriptions from a provided prescriptions list to treat the patient user;
recording the medical information, the prescription management information and the provided diagnosis list in a web database system residing on the website;
and
giving the Medicaid provider or the health insurance carrier a predetermined period of time for the prescription and one or more differing dosages.

12. The method according to claim 11, wherein the one or more prescriptions are regulated by state law as one or more controlled substances and are dispensed by a pharmacy.

13. The method according to claim 11, wherein the prescription remains on the web database system until it is filled by an authorized pharmacy.

14. The method according to claim 13, wherein the authorized pharmacist receives the prescription automatically.

15. The method according to claim 11, wherein notification of the patient's side effects of medication and record of transaction is sent to their email.

16. A non-transitory computer storage media having instructions stored thereon which, when executed, execute a method comprising the steps of:
a patient user enrolling in a Medicaid or health insurance plan on a website;
assigning or having the patient user selects a provider who authorizes one or more prescriptions;
receiving medical information from the healthcare provider and integrating the medical information with prescription management information;
selecting one or more economical prescriptions from a provided prescriptions list to treat the patient user;
recording the medical information, the prescription management information and the provided diagnosis list in a web database system residing on the website; and
giving the Medicaid provider or the health insurance carrier a predetermined period of time for the prescription and one or more differing dosages.

17. The non-transitory computer storage media according to claim 16, wherein the one or more prescriptions are regulated by state law as one or more controlled substances and are dispensed by a pharmacy.

18. The non-transitory computer storage media according to claim 16, wherein the prescription remains on the web database system until it is filled by an authorized pharmacy.

19. The non-transitory computer storage media according to claim 18, wherein the authorized pharmacist receives the prescription automatically.

20. The non-transitory computer storage media according to claim 16, wherein notification of the patient's side effects of medication and record of transaction is sent to their email.
